(19) United States
(12) Patent Application Publication
(10) Pub. No.: US 2024/0344155 A1
(43) Pub. Date: Oct. 17, 2024

(54) METHOD FOR PRODUCING AN IRON MELT

(71) Applicant: ThyssenKrupp Steel Europe AG, Duisburg (DE)

(72) Inventors: Frank AHRENHOLD, Duisburg (DE); Roswitha BECKER, Duisburg (DE); Nils JÄGER, Mülheim (DE); Daniel SCHUBERT, Duisburg (DE); Matthias WIENBERG, Krefeld (DE)

(73) Assignee: ThyssenKrupp Steel Europe AG, Duisburg (DE)

(21) Appl. No.: 18/682,221

(22) PCT Filed: Aug. 22, 2022
(86) PCT No.: PCT/EP2022/073307

§ 371 Date: Feb. 8, 2024

(30) Foreign Application Priority Data
Aug. 30, 2021 (DE) 10 2021 122 351.2

(51) Int. Cl. C21B 13/00; C21B 13/02

(52) U.S. Cl. CPC C21B 13/0006; C21B 13/00; C21B 13/0033; C21B 13/0086; C21B 13/023; C21B 2100/00

(57) ABSTRACT

The present disclosure relates to a process for producing an iron melt. The method includes; reducing iron ore to sponge iron, carburizing sponge iron with a carbonaceous gas, melting the carburized sponge iron and/or treating the melt produced from the carburized sponge iron. According to the present disclosure, the carbonaceous gas is at least a portion of the process gas obtained in the melting of the carburized sponge iron and/or treating of the melt produced from the carburized sponge iron that has been recycled.

### FIELD

The invention relates to a process for producing an iron melt, comprising the steps of:—reducing iron ore to sponge iron,—carburizing sponge iron with a carbonaceous gas,—melting the carburized sponge iron and/or treating the melt produced from the carburized sponge iron.

### BACKGROUND OF THE INVENTION

In the direct reduction method, a solid-state reaction takes place, in which oxygen is removed from the iron ore. For this purpose, gasified coal and/or natural gas or hydrocarbonaceous compounds and mixtures of the feedstocks mentioned, especially with hydrogen and/or compounds of carbon and oxygen, are used as reduction gas. The trend in recent times has been that there have been more frequent proposals of hydrogen as reduction gas. The reaction takes place below the melting point of the iron ore in the solid state, such that, in particular, the internal form remains very substantially unchanged. In the reduction of iron ore down to the metallic product, basically only the oxygen present in the ore is removed. Since there is a reduction in weight of about ¼ to ⅓ in the removal of oxygen, the result is a honeycomb structure of the reaction product (solid porous iron with many air-filled interstices). Therefore, direct reduced iron is frequently also referred to as sponge iron.

The applicant's published specification DE 10 2019 217 631 A1 additionally discloses that the sponge iron which is still hot after reduction is cooled with a cooling gas comprising a mixture of carbon dioxide and hydrogen in a particular ratio. According to the teaching, the cooling gas can be used thereby to increase the carbon content in the sponge iron.

For future primary steel production, the blast furnace routes will be gradually replaced by direct production plants in conjunction with melting aggregates in order to cover the continuing global demand for steel. For this purpose, in the course of the transformation, direct production plants will be set up on the mill floor in the vicinity of the existing blast furnace(s), such that parallel operation will also be possible for certain period of time; cf., inter alia, EP 1 641 945 B1.

As a result of climate-related restrictions or in order to achieve ambitious climate aims, the direct production plants operated with natural gas according to current prior art are likely to be operated with hydrogen or hydrogen-rich gases in the future.

It is known from the iron-carbon diagram that the carbon content in the solid material to be melted has a significant influence on the enthalpy of fusion of the substance. The higher the carbon content (up to 4.7% by weight), the lower the melting temperature and hence the amount of energy required or else the electrode consumption in the melting aggregates. Low temperatures also mean lower wear of the refractory material in the melting aggregates. In addition, lower radiative losses also result in a reduced energy consumption.

Steel converters for refining and/or conditioning the pig iron removed from the blast furnace are among the apparatuses present in an integrated smelter. For instance, it is also possible to operate the aggregates present for the direct reduction mode. Especially in the case of refining in the converter, the oxygen blast process, a defined proportion of carbon in the blasting process is needed from a metallurgical point of view. In order to provide a defined carbon, DE 10 2019 217 631 A1, for example, discloses how the carbon content in the sponge iron can be increased in a controlled manner and adjusted as required.

It is an object of the present invention to develop this process so as to specify a CO₂-neutral or reduced-CO₂ mode of production of iron melts.

This object is achieved by a process for producing an iron melt, comprising the steps of:—reducing iron ore to sponge iron,—carburizing sponge iron with a carbonaceous gas,—melting the carburized sponge iron and/or treating the melt produced from the carburized sponge iron, wherein the carbonaceous gas is at least a portion of the process gas obtained in the melting of the carburized sponge iron and/or treating of the melt produced from the carburized sponge iron that has been recycled.

In order to specify a CO₂-neutral or reduced-CO₂ mode of production of iron melt, the inventors have found that at least portions of the process gases from the process chain can be utilized. This has the advantage that the carbon present in the carbonaceous gas for carburization of the sponge iron is at least partly recycled and it is therefore possible to ensure closed circulation up to an extent of 100%. As well as economic aspects, significant benefits are also assured from an environmental point of view. If the recycled carbonaceous gas does not cover the demands on the carburization of the sponge iron, additional carbonaceous media can be added to the recycled carbonaceous gas in order to be able to keep the carburization at the desired level. In order to comply with climatic goals, it is not absolutely necessary to resort to biogenic carbon, which does not usually come from sustainable sources.

The carbon from the carbonaceous gas that flows through the sponge iron “carburizes” the sponge iron, such that carbon is deposited on the sponge iron. The carbon deposited then combines with the iron to form cementite (Fe₃C). The carbon content of the sponge iron after treatment with the carbonaceous gas is greater than 0.5% by weight, especially greater than 1.0% by weight, preferably greater than 1.5% by weight, and less than 4.5% by weight, especially less than 4.0% by weight, preferably less than 3.5% by weight.

The carburized sponge iron can either be melted in a blast furnace on the one hand or, preferably, in an electrical furnace on the other hand. The carbonaceous gas may thus be at least a portion of the process gas obtained in the melting of the carburized sponge iron that has been recycled, either in the form of blast furnace gas or in the form of electrical furnace gas, which is utilized physically as carbonaceous gas for carburization of the sponge iron.

Alternatively or additionally, the melt produced from the carburized sponge iron can be treated when the carbon in the melt is to be reduced to a necessary degree for further processing. This can be effected, for example, by means of oxygen in what is called an oxygen blast process, in order to remove carbon from the melt in the form of carbon monoxide and/or carbon dioxide, where this oxygen blast process can be integrated within the furnace, for example in the electrical furnace, especially in a further stage, or can be conducted conventionally in a converter. The process gas obtained by the treating of the melt produced from the carburized sponge iron is carbonaceous and can be at least partly recycled as carbonaceous gas.

The at least partly recycled process gas as carbonaceous gas comprises proportions of CO and/or CO₂. In order to reduce unwanted process-related trace elements, for example nitrogen and/or nitrogen oxides, in the recycled process gas, separation and/or removal processes may preferably be provided in order to be able to provide a carbonaceous gas comprising proportions of CO and/or CO₂ of more than 50% by volume, especially more than 55% by volume, preferably more than 60% by volume, more preferably more than 65% by volume, further preferably more than 70% by volume.

The carbonaceous gas may optionally comprise proportions of water vapor (H₂O) up to 15% by volume and/or hydrogen (H₂) up to 30% by volume. If proportions of nitrogen (N₂) should optionally be present, these should be limited to a content of especially max. 25% by volume, preferably max. 20% by volume, more preferably max. 15% by volume, further preferably max. 10% by volume. In addition, the carbonaceous gas may also contain unavoidable impurities down to 2% by volume, for example sulfur compounds.

The operations or the mode of operation for production of an iron melt with addition of carburized sponge iron in a blast furnace or in an electrical furnace, especially also by supply of further additives or admixtures, is familiar in practice.

In one configuration of the process, a hydrogenous reduction gas is used for reduction. The hydrogenous reduction gas includes methane (CH₄) and/or hydrogen (H₂) as the main constituent.

For this purpose, it is possible to use natural gas (NG), for example, which comprises essentially methane. Alternatively, especially in order to conserve resources and/or to reduce the CO₂ output over the entire process chain in question, it is also possible to produce methane from renewable raw materials, for example from biomass or biogas production, and hence effectively biomethane.

The hydrogenous reduction gas may also contain a mixture of methane (CH₄) and hydrogen (H₂).

The hydrogenous reduction gas may consist of hydrogen and be free of carbon. This allows reduction work to be performed all the more effectively when hydrogen only is used. Hydrogen can be produced in different ways, for example by reforming methods or water electrolysis. The industrial production of hydrogen is energy-intensive, and so preference is given to employing renewable energies (wind, water, sun) and/or reduced-CO₂ technologies, for example nuclear energy, and not, or not exclusively, fossil energy.

The hydrogenous reduction gas may contain further constituents such as water vapor and unavoidable impurities, for example sulfur compounds and/or nitrogen.

In one configuration of the process, the hydrogenous reduction gas is heated to a temperature between 500 and 1200° C. Before being fed in, the hydrogenous reduction gas is heated to the required temperature in a gas heater, in order to bring about the reduction of the iron ore. In the case of feeding of (essentially 100%) hydrogen, feeding can be effected without additional charging in particular of oxygen and hence postcombustion therewith, meaning that the complete utilization of the hydrogen for the reduction of the iron ore is assured and hence the process can be operated in a more economically viable manner. Depending on the hydrogen content, there is no need to heat the hydrogenous reduction gas to such high process temperatures since the reduction of the iron ore (cf. Baur-Glassner diagram) can take place at low temperatures.

In a preferred configuration of the process, the melting is conducted in an electrical furnace, especially in an electrical reduction furnace. Electrical reduction furnaces (submerged electric arc furnaces, SAFs for short) are melting furnaces with arc resistance heating which form arcs between the electrode and the charge and/or the slag, or which heat the charge and/or slag by means of the joule effect. In the SAF, the electrode is (or the electrodes, if there are two or more, are) immersed into the charge and/or slag. Depending on the principle of function/mode of operation, the electrical reduction furnaces may be designed as AC arc reduction furnaces (SAFac) or DC arc reduction furnaces (SAFdc). The principle of function/mode of operation differs from the melting furnaces with direct arcing (electric arc furnaces, EAFs), which form arcs between the electrode and the metal. This includes the AC arc melting furnace (EAFac), the DC arc melting furnace (EAFdc) and the ladle furnace (LF).

The advantage in the case of use of electrical reduction furnaces with arc resistance heating (SAFs) is that these are operated with a reducing atmosphere, whereas arc furnaces with direct arcing (EAFs) are operated with an oxidizing atmosphere.

In an alternative configuration of the process, the melting is conducted in a blast furnace.

If it is not possible to use the sponge iron coming from a reduction furnace while hot at a temperature of up to 800° C., for example, the sponge iron is cooled down for onward transport and/or for storage. In one configuration of the process, the carbonaceous gas is fed in at a temperature below 100° C. to cool the sponge iron. The carbonaceous gas has the function not only of carburizing but also of cooling the sponge iron.

In alternative configuration of the process, the carbonaceous gas is fed in at a temperature of at least 500° C. Before being fed in, the carbonaceous gas is heated to the required temperature in a gas heater. This variant serves in particular for use of the sponge iron while hot, preferably in an electrical furnace. The higher the chosen temperature of the sponge iron, the better the reaction kinetics of the sponge iron. In order to increase efficiency, the temperature can especially be raised to at least 600° C., preferably to at least 700° C., more preferably to at least 800° C., especially preferably to at least 900° C., further preferably to at least 1000° C. In order to be able to ensure non-problematic charging of the hot sponge iron, preferably into the electrical furnace, and to avoid premature melting of sponge iron, the melting temperature of sponge iron on heating must not be exceeded, and so the temperature should be not more than 1500° C., especially not more than 1400° C., preferably 1300° C. The carbonaceous gas has the function not only of carburizing but also of heating the sponge iron in order to reduce the expenditure of electrical energy from melting in the electrical furnace.

In one configuration of the process, the iron ore passes through a shaft furnace in vertical direction, from the top downward. Such shaft furnaces enable good flow of reduction gas through the iron ore because of the underlying chimney effect. In particular, the reduction gas flows through counter to a direction of movement of the iron ore.

In a specific variant of the process, the sponge iron is cooled or heated in the lower portion of the shaft furnace. As a result, the iron ore can be reduced in the upper portion of the shaft furnace and the sponge iron can be cooled or heated in the lower portion. It is also the case that the carbonaceous gas flows through the sponge iron counter to a direction of movement of the sponge iron because of the underlying chimney effect.

In an alternative variant of the process, the reduction of the iron ore can be conducted in one or more fluidized bed reactors and the carburization of the sponge iron in one or more fluidized bed reactors. In a fluidized bed reactor, a bed of fine grains of solid material is fluidized by the gas flowing in continuously from the bottom through a gas distributor. This likewise enables an efficient reaction between the gases and the solids.

The invention is elucidated in more detail by the working examples that follow, in conjunction with FIG. 1.

### BRIEF DESCRIPTION OF DRAWINGS

The invention is explained in greater detail below with reference to drawings. Identical parts are provided with the same reference signs. More particularly:

FIG. 1 shows a sequence relating to the production of a sheet metal component according to one embodiment of the method according to the invention and of the device according to the invention in a schematic sectional view, and

FIG. 2 shows a perspective illustration of a simulation of a sheet metal preform and of a sheet metal component resulting therefrom.

### DETAILED DESCRIPTION OF THE DRAWINGS

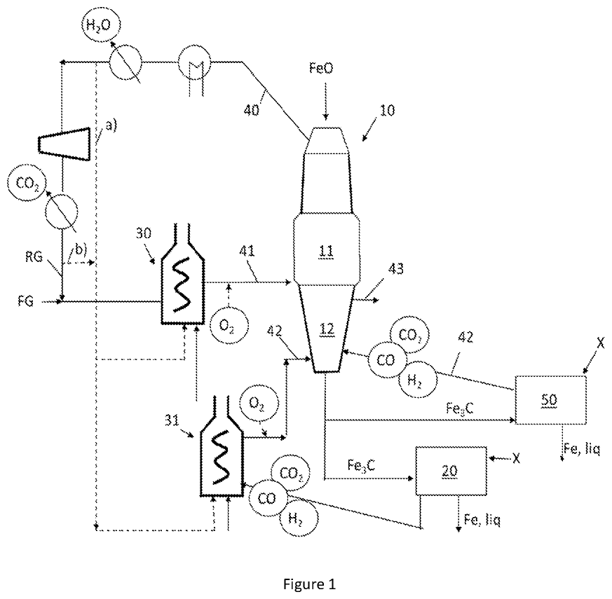

FIG. 1 elucidates the invention using the example of a shaft furnace (10). Iron ore (FeO), for example in pellet form comprising Fe₂O₃ and/or Fe₃O₄ and gangue, is introduced at the upper end of the shaft furnace (10). At the lower end of the shaft furnace (10), the sponge iron is removed. In the shaft furnace (10), there is a region for reducing the iron ore in the form of a reduction zone (11) and a region for carburizing the iron ore in the form of a cooling zone/heating zone (12). The reduction zone (11) is disposed above the cooling zone/heating zone (12). A hydrogenous reduction gas (41) flows through the iron ore in the reduction zone (11) in countercurrent, and hence counter to the direction of movement of the iron ore. The hydrogenous reduction gas (41), before being introduced, is passed through a gas heater (30) and heated to a temperature of up to 1200° C. The hydrogenous reduction gas (41) comprises a fresh gas (FG), either natural gas (methane, CH₄) or hydrogen (H₂) or a mixture thereof. The fresh gas (FG) may be mixed with a recycled processed gas (RG) which is processed from the process gas (40) discharged from the reduction zone (11) of the shaft furnace (10). The discharged process gas (40) composed of unconsumed reduction gas may be composed of any gaseous reaction products. The discharged process gas (40) may comprise hydrogen (H₂), at least one compound or mixture of carbon and oxygen (CO, CO₂) and/or at least one hydrogenous compound (H₂O) and unavoidable impurities. The discharged process gas (40) may be fed to a first process step in which at least one compound or mixture of the process gas and/or at least portions of the unavoidable impurities are separated out and/or removed, for example in a unit for process gas cleaning and dedusting, in which at least a portion of the unavoidable impurities is separated from the discharged process gas (40). In a further process step, the process gas can be passed through a unit, for example through a condenser, and correspondingly cooled, such that the water vapor (H₂O) present in the process gas is condensed and hence separated from the process gas. The condensing and discharge of the condensate “dehumidifies” the process gas. A portion of the “dehumidified” process gas or the fully “dehumidified” process gas, shown by dashed lines, can be used as (a portion of the) gas a) for firing of the gas heater (30, 31). If not enough “dehumidified” process gas should be available, a corresponding combustion gas is provided partly or completely for firing of the gas heater (30, 31). If a portion of the “dehumidified” process gas or the entirety of the “dehumidified” process gas is not provided for firing of the gas heater (30, 31), carbon dioxide (CO₂) can be separated out of the “dehumidified” process gas in a further process step, if present, for example in a scrubber. The process gas that has been freed of carbon dioxide can be used wholly or partly, shown by dashed lines, as (a portion of the) gas b) for firing of the gas heater (30, 31). If insufficient gas b)/an insufficient portion of gas b) should be available, a corresponding combustion gas is provided partly or completely for firing of the gas heater (30, 31). The process gas freed of carbon dioxide or recycled processed gas (RG) may also additionally alternatively be fed back to the direct reduction in a further process step by mixing it with the fresh gas (FG), especially before the mixture is heated to a temperature between 500 and 1200° C. in the gas heater (30). Optionally, and therefore shown by dashed lines, oxygen (O₂) may additionally be fed into the hot reduction gas (41), in order to increase the reactivity of the hydrogenous reduction gas (41) in the reduction zone (11) and hence the heat input.

After leaving the reduction zone (11), the sponge iron enters the cooling zone/heating zone (12). The sponge iron here is at a temperature of up to 800° C. In the cooling zone/heating zone (12) too, carbonaceous gas (42) flows through the sponge iron counter to the direction of movement of the sponge iron. Unconsumed cooling gas exits again as process gas (43) together with any gaseous reaction products. Depending on the use, the carbonaceous gas (42) may be fed in at a temperature below 100° C. to cool the sponge iron or fed in at a temperature of at least 500° C. to heat the sponge iron.

The carburized sponge iron (Fe₃C) together with the gangue is withdrawn in the lower region of the shaft furnace (10) and either fed in heated form directly to an electrical furnace, preferably in the form of an electrical reduction furnace (20) for melting, or transported onward in cooled form to a blast furnace (50), or (not shown) provided in cooled form for storage.

In the melting of the carburized sponge iron (Fe₃C), it is possible to introduce additives or admixtures (X) both in the electrical furnace (20) and in the blast furnace (50).

What is not shown is how the iron melt is withdrawn and fed to a further processing step. The iron melt, either from the electrical furnace (20) or from the blast furnace (50), is preferably sent to a treatment of the melt produced from the carburized sponge iron, in order to reduce the carbon in the melt to a necessary degree. This is effected, for example, by means of oxygen in what is called an oxygen blast process, more preferably in a converter. The process gas obtained by the treatment of the melt produced from the carburized sponge iron is carbonaceous and is recycled at least partly as carbonaceous gas. If the desired carburization level can be maintained, there is no need to add any carbonaceous media, and the recycled process gas is sufficient as carbonaceous gas for carburization.

The preferred mode of operation for direct reduction of iron ore (FeO) to sponge iron envisages hydrogen (H₂) as fresh gas (FG) and hence as hydrogenous reduction gas (41), which does not undergo any mixing with a recycled processed gas (RG) and, after heating to a temperature between 50° and 1200° C., is introduced into the reduction zone (11) of the shaft furnace (10). The process gas (40) discharged above the reduction zone (11) from the shaft furnace (10), as shown in FIG. 1, after “dehumidification” thereof, is fed in its entirety as combustion gas (as gas a)) to the gas heater (30, 31), shown by dashed lines, and is not fed to and mixed with the fresh gas (FG).

In a first variant of the preferred mode of operation, a carbonaceous gas (42) with a CO and/or CO₂ content as its main constituent is introduced into the cooling zone (12) for carburizing and cooling. The carburized and cooled sponge iron can either be introduced into the blast furnace (50) or into the electrical furnace (20) for melting. Depending on the use of the sponge iron, it is either possible to provide the process gas from the blast furnace (50) or the process gas from the electrical furnace (20) as carbonaceous gas (42). Alternatively or additionally, it is also possible to recycle the process gas obtained from the treatment of the melt produced from the carburized sponge iron at least partly as carbonaceous gas.

In a second variant of the preferred mode of operation, a carbonaceous gas (42) with a CO and/or CO₂ content as its main constituent is introduced into the heating zone (12) for carburizing and heating. The carburized and heated sponge iron is introduced into the electrical furnace (20), which can reduce the expenditure of electrical energy for melting. The carbonaceous gas (42) provided may be the process gas from the electrical furnace (20). Alternatively or additionally, it is also possible for the process gas obtained from the treatment of the melt produced from the carburized sponge iron to be recycled at least partly as carbonaceous gas.

What is not shown is that the recycled process gas, if required, can be fed to units for removal of unwanted trace elements prior to provision as carbonaceous gas (42), for example in order to set the nitrogen content at less than 25% by volume.

Alternatively, and not shown here, the invention can also be implemented in a cascade of fluidized bed reactors. In this case, at least one fluidized bed reactor forms a reduction zone and, according to circumstances, at least one further fluidized bed reactor in the cascade a cooling zone or heating zone, in each case combined with carburization. Thus, the iron ore in a first fluidized bed reactor would possibly also be converted to sponge iron in a second successive reactor and hence in a stepwise manner. In the last fluidized bed reactor, or possibly in the last two fluidized bed reactors, the sponge iron, as well as the carburization, is cooled or heated depending on the temperature of the carbonaceous gas. The principle corresponds essentially to that of a shaft furnace, but divided between multiple fluidized bed reactors rather than one shaft. The number of fluidized bed reactors may be connected to one another if required.

1. A method process for producing an iron melt, comprising the steps of:
reducing iron ore to sponge iron,
carburizing sponge iron with a carbonaceous gas,
at least one of melting the carburized sponge iron and/or treating the melt produced from the carburized sponge iron,
wherein the carbonaceous gas is at least a portion of a process gas obtained in the at least one of the melting of the carburized sponge iron and/or treating of the melt produced from the carburized sponge iron that has been recycled.

2. The method process as claimed in claim 1, wherein the reduction is effected using a hydrogenous reduction gas.

3. The method process as claimed in claim 2, wherein the hydrogenous reduction gas is heated to a temperature between 50° and 1200° C.

4. The method process as claimed in claim 2, wherein the melting is conducted in an electrical reduction furnace.

5. The method as claimed in claim 3, wherein the melting is conducted in a blast furnace.

6. The method of claim 5, wherein the carbonaceous gas is fed in at a temperature below 100° C. to cool the sponge iron.

7. The method of claim 5, wherein the carbonaceous gas is fed in at a temperature of at least 500° C. to heat the sponge iron.

8. The method of claim 5, wherein the iron ore passes through a shaft furnace in vertical direction.

9. The method of claim 8, wherein the sponge iron is one of cooled and heated in the lower portion of the shaft furnace.

10. The method of claim 7, wherein the iron ore is reduced in at least one fluidized bed reactors and the sponge iron is carburized in at least one fluidized bed reactors.

11. A method for producing an iron melt, comprising the steps of:
reducing iron ore to sponge iron;
carburizing sponge iron with a carbonaceous gas, the carbonaceous gas being at least partially recycled carbonaceous gas;
melting the carburized sponge iron; and
treating the melt produced from the carburized sponge iron;
wherein the carbonaceous gas is of a process gas obtained in the melting of the carburized sponge iron and treating of the melt produced from the carburized sponge iron is the at least partially recycled carbonaceous gas.

12. The method as claimed in claim 11, wherein the reduction is effected using a hydrogenous reduction gas.

13. The method as claimed in claim 12, wherein the hydrogenous reduction gas is heated to a temperature between 50° and 1200° C.

14. The method as claimed in claim 12, wherein the melting is conducted in an electrical reduction furnace.

15. The method as claimed in claim 14, wherein the melting is conducted in a blast furnace.

16. The method of claim 15, wherein the carbonaceous gas is fed in at a temperature below 100° C. to cool the sponge iron.

17. The method of claim 15, wherein the carbonaceous gas is fed in at a temperature of at least 500° C. to heat the sponge iron.
